(19) United States
(12) Patent Application Publication
(10) Pub. No.: US 2013/0106778 A1
(43) Pub. Date: May 2, 2013

(54) CAPACITIVE TOUCH PANEL AND METHOD FOR MANUFACTURING A CAPACITIVE TOUCH PANEL

(71) Applicant: SENTELIC TECHNOLOGY CO., LTD., Taipei (TW)

(72) Inventors: JAO-CHING LIN, Taipei (TW); LINABEL CHU, Taipei (TW); CHUNG-YI SHEN, Taipei (TW)

(73) Assignee: SENTELIC TECHNOLOGY CO., LTD., Taipei (TW)

(21) Appl. No.: 13/662,495

(22) Filed: Oct. 28, 2012

(30) Foreign Application Priority Data
Oct. 28, 2011 (TW) 100139368

(51) Int. Cl. G06F 3/044; H01H 65/00

(52) U.S. Cl. 345/174; 29/622

(57) ABSTRACT

Approach is provided for a capacitive touch panel. The capacitive touch panel comprises a substrate, multiple tracing units, an insulating layer and an electrode layer. The tracing units are spaced at intervals on a first surface of the substrate along a first direction. The insulating layer formed on the substrate covers the tracing units, and comprises multiple connecting hole units. The electrode layer is printed on an outer surface of the insulating layer, and comprises multiple first electrode rows and electrode units. The first electrode rows are spaced at intervals along the second direction, and the electrode units are spaced at intervals along the first direction that comprises multiple electrodes spaced at intervals along the second direction, wherein the electrodes of the electrode units are electrically connected to the tracing units through the corresponding connecting hole units that form second electrode rows along the second direction.

### FIELD OF THE INVENTION

Embodiments of the invention relate to touch panel, and more particularly to capacitive touch panels and methods for manufacturing a capacitive touch panel.

### BACKGROUND

A touch panel detects the locations of touches within the display area, and may are classified into many types of panels, such as a resistive touch panel, a capacitive touch panel, a surface acoustic wave touch panel and an optical touch panel. The capacitive touch panel, in general, senses an induced current caused by a touch of an object (i.e. a stylus or a human finger) to determine locations of the touch.

The United States published application No. US2012/0295818A1 has disclosed a capacitive touch panel that comprises a copper made first electrode unit formed on a printed circuit board (PCB) and a second electrode unit. The second electrode unit is made of carbon ink, which is formed on an insulating layer coated on the first electrode unit. This disclosed capacitive touch panel reduces manufacturing cost due to the complex structure of the prior capacitive touch panel. However, such disclosed capacitive touch panel requires a highly precisely positioned machinery for avoiding the overlapped of electrodes between the first electrode unit and the second electrode unit, which ensures precise sensing ability.

Therefore, there is a need for an approach to provide mechanisms or means that can adapt to capacitive touch panel manufactures without using the highly precisely positioned machinery, and remain lower production cost.

### Some Exemplary Embodiments

These and other needs are addressed by the invention, wherein an approach is provided for a capacitive touch panel structure with a reliable aligning arrangement of the electrodes. Another approach is to provide a method for manufacturing the capacitive touch panel with reliable aligned electrodes arrangement.

According to one aspect of an embodiment of the invention, a capacitive touch panel comprises a substrate, multiple tracing units, an insulating layer and an electrode layer. The substrate has a first surface and a second surface. The tracing units are spaced at intervals on the first surface of the substrate along a first direction, and each tracing unit is duplicated along a second direction. The insulating layer is formed on the first surface of the substrate, covering the tracing units, and comprises multiple connecting hole units penetrated to the corresponding tracing unit. The electrode layer is printed on an outer surface of the insulating layer and comprises multiple first electrode rows and multiple electrode units. The first electrode rows are spaced at intervals along the second direction, and are duplicated along the first direction. The electrode units are spaced at intervals along the first direction, and are duplicated along the second direction that comprise multiple electrodes spaced at intervals along the second direction, wherein the electrodes of the electrode units are electrically connected to the tracing units through the corresponding connecting hole units that forms multiple second electrode rows along the second direction.

In one embodiment, the tracing unit may be made from a metal such as cooper.

In one embodiment, the electrode layer may be made from a conductive ink, and the conductive ink may selected from a group consisting of a silver ink, an aluminum ink, a silver-aluminum ink and a carbon ink.

In one embodiment, each tracing unit comprises multiple striped traces spaced at intervals along the second direction. Each connecting hole unit comprises multiple connecting holes along the second direction, and the every two connecting holes are corresponded respectively to two opposite end of the corresponding striped traces of the tracing units, wherein the striped traces of the tracing units are electrically connected to the two adjacent electrodes of the electrode units through the corresponding connecting holes.

Alternatively, in another embodiment, the connecting holes of the connecting hole unit corresponded to the electrodes of the corresponding second electrode unit, wherein the striped trace is electrically connected to the electrodes of the corresponding electrode unit through the corresponding connecting holes.

In one embodiment, the capacitive touch panel further comprises a processing unit mounted on the second surface of the surface. The processing unit is electrically connected to the first electrode rows and the second electrode rows, which receives the signals from the first electrode rows and the second electrode rows.

In one embodiment, the electrode may be shaped in a diamond-shape or a triangular shape, and/or the first direction may perpendicular to the second direction.

According to another aspect of an embodiment of the invention, a method for manufacturing a capacitive touch panel comprises acts of forming multiple tracing units spaced at intervals along a first direction on a first surface of the substrate, forming an insulating layer covered on the tracing units on the first surface of the substrate, forming multiple connecting hole units on the insulating layer, and printing an electrode layer on a outer surface of the insulating layer that is away from the substrate. Each tracing unit is extended along the second direction that intersects the first direction. The connecting hole units penetrate to the corresponding tracing units. The electrode layer comprises multiple first electrode rows and multiple electrode units, the first electrode rows are spaced at intervals along the second direction, and duplicating along the first direction, and the electrode units are spaced at intervals along the first direction, and duplicating along the second direction that comprises multiple electrodes spaced at intervals along the second direction, wherein the electrodes of the electrode units are electrically connected to the tracing units through the corresponding connecting holes that forms multiple second electrode rows along the second direction

In one embodiment, the method for manufacturing a capacitive touch panel further comprises acts of mounting a processing unit on the second surface of the substrate electrically connected to the first electrode rows and the second electrode rows, which receives the signals from the first electrode rows and the second electrode rows.

Accordingly, the capacitive touch panel and the method for manufacturing a capacitive touch panel is configured to form the first electrode rows and the second electrode rows printed on the insulating layer. Since the first electrodes of the first electrode rows and the second electrodes of the first electrode rows are formed substantially at same layer of a capacitive touch panel, it reduces the complexity of electrode alignments for positioning process during the manufacture. The accuracy of the touching detection is remained.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is flow chart of the method for manufacturing a capacitive touch panel in accordance with an embodiment of the present invention;

FIG. 2 is an exemplary diagram of a capacitive touch panel in accordance with an embodiment of the present invention, which illustrating multiple tracing units that are formed on the substrate;

FIG. 3 is a cross-sectional view along the line in the FIG. 2;

FIG. 4 is an exemplary diagram of a capacitive touch panel in accordance with an embodiment of the present invention, which illustrating the insulating layer is formed on the substrate covering the tracing units;

FIG. 5 is a cross-sectional view along the V-V line in the FIG. 4;

FIG. 6 is an exemplary diagram of a capacitive touch panel in accordance with an embodiment of the present invention, which illustrating multiple connecting hole units are formed on the insulating layer;

FIG. 7 is a cross-sectional view along the VII-VII line in the FIG. 6;

FIG. 8 is an exemplary diagram of a capacitive touch panel in accordance with an embodiment of the present invention, which illustrating an electrode layer formed on the insulating layer, and a processing unit connected to the substrate;

FIG. 9 is a cross-sectional view along the IX-IX line in the FIGS. 8; and

FIG. 10 is cross-sectional view of a capacitive touch panel in accordance with another embodiment of the present invention.

### DESCRIPTION OF THE PREFERRED EMBODIMENT

In the following description, for purposes of explanation, numerous specific details are set forth in order to provide a thorough understanding of the embodiment of the invention. It is apparent, however, to one skilled in the art that the present invention may be practiced without these specific details or with an equivalent arrangement. Same element in various embodiments of the present invention may use same numbering in different illustrated figures.

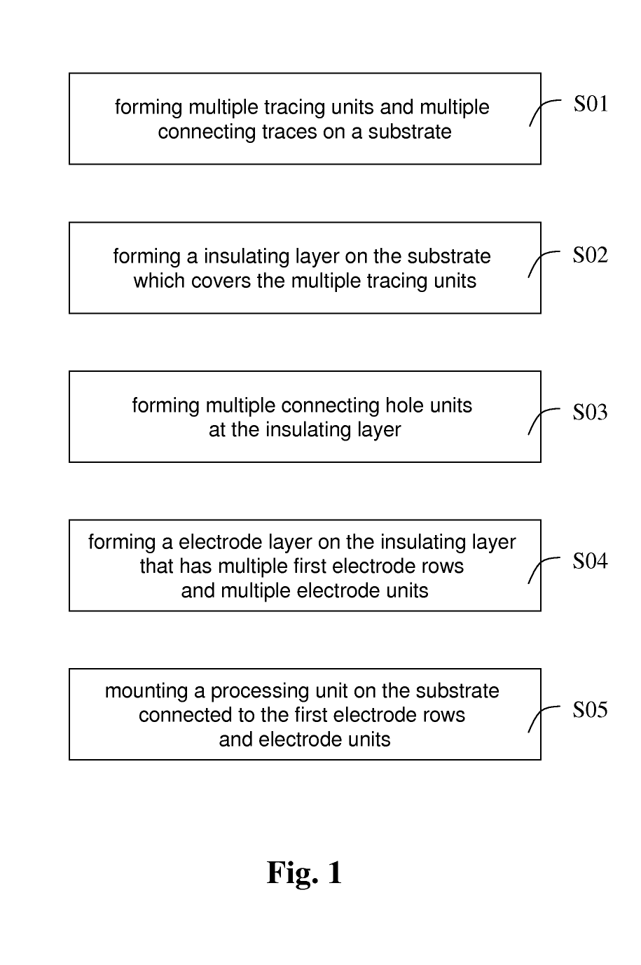

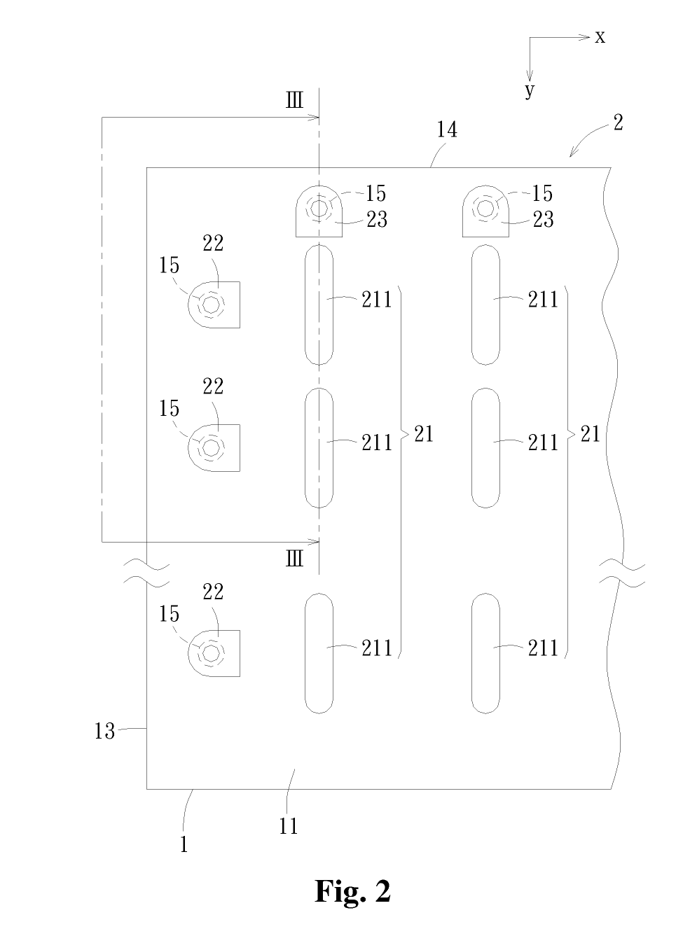

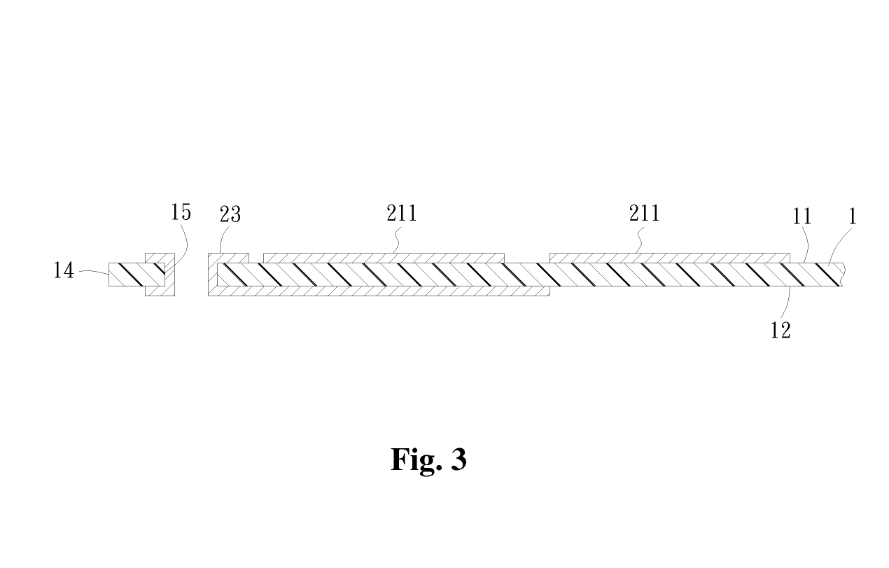

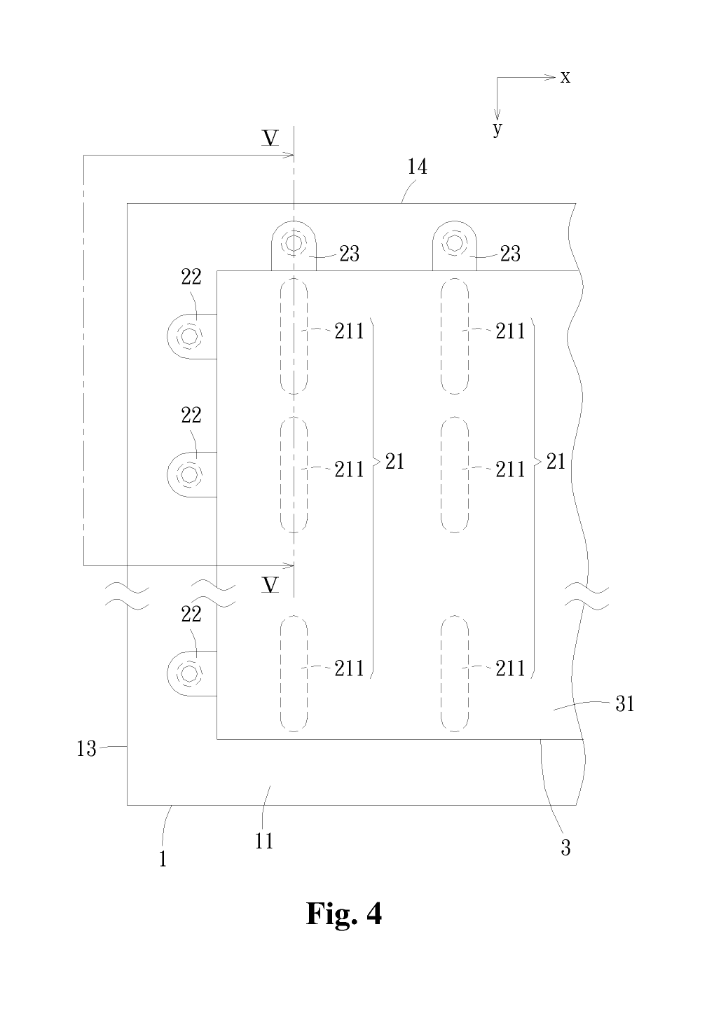

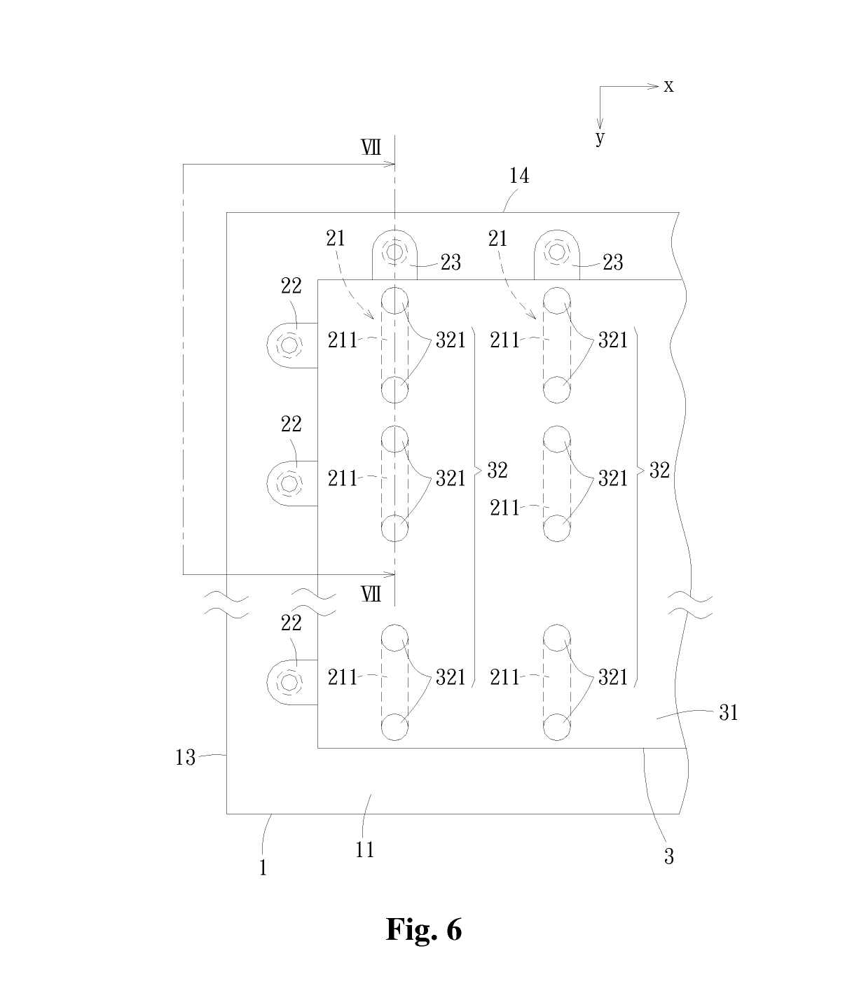

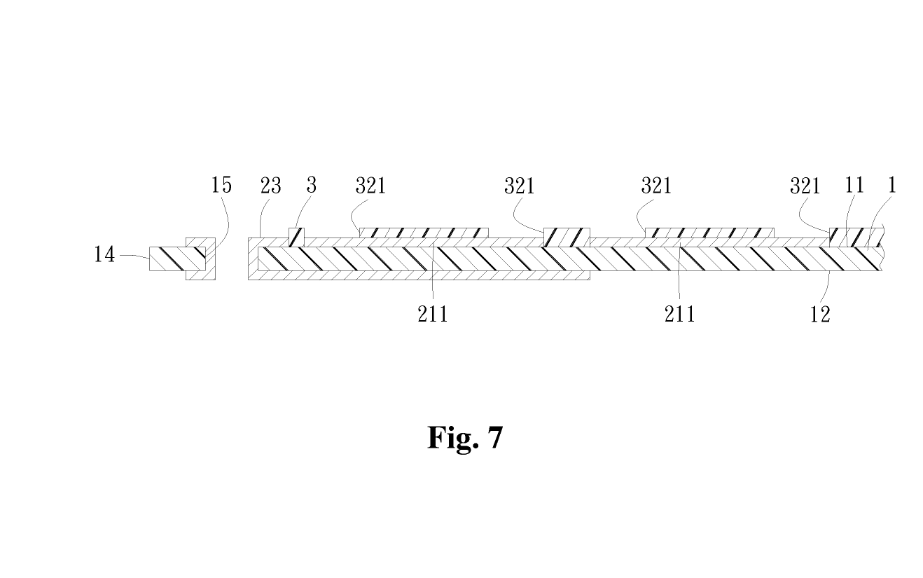

With reference to FIGS. 1 to 9, embodiments of the capacitive touch panel and method for manufacturing a capacitive touch panel are disclosed. FIG. 1 is a flow chart of the method for manufacturing a capacitive touch panel, and FIGS. 2 to 9 are exemplary diagrams of the capacitive touch panel to the corresponding steps of FIG. 1.

As shown in FIG. 1, the method for manufacturing a capacitive touch panel comprises acts of S01 forming multiple tracing units and multiple connecting traces on a substrate, S02 forming an insulating layer on the substrate which covers the multiple tracing units, S03 forming multiple connecting hole units at the insulating layer, S04 forming an electrode layer on the insulating layer that has multiple first electrode rows and multiple electrode units, and S05 mounting a processing unit on the substrate connected to the first electrode rows and electrode units.

With reference to FIGS. 1, 2 and 3, in step S01, a tracing layer 2 is formed both on a first surface 11 and a second surface 12 of a substrate 1. The tracing layer 2 is made from a metal. In one example, the tracing layer 2 is made of copper. In an embodiment, the substrate 1 may be a standardized FR-4 printed circuit board (PCB).

The substrate 1 has a first edge 13, a second edge 14, and comprises multiple holes 15. The holes 15 are formed respectively along a first direction (i.e. x-axis) and a second direction (i.e. y-axis) that are adjacent to the first edge 13 and the second edge 14. The tracing layer 2 comprises multiple tracing units 21, multiple first connecting traces 22 and multiple second connecting traces 23. The tracing units 21 are formed on the first surface 11, are spaced at intervals along the first direction, and are expansively duplicated along the second direction. The first direction intersects the second direction. Each tracing unit 21 comprises multiple striped traces 211 spaced at intervals along the second direction.

Each first connecting trace 22 is formed on the first surface 11 and penetrates through the hole 15 to the second surface 12 that is adjacent to the first edge 13. Each second connecting trace 23 is formed on the first surface 11 and penetrates through the hole 15 to the second surface 12 that is adjacent to the second edge 14.

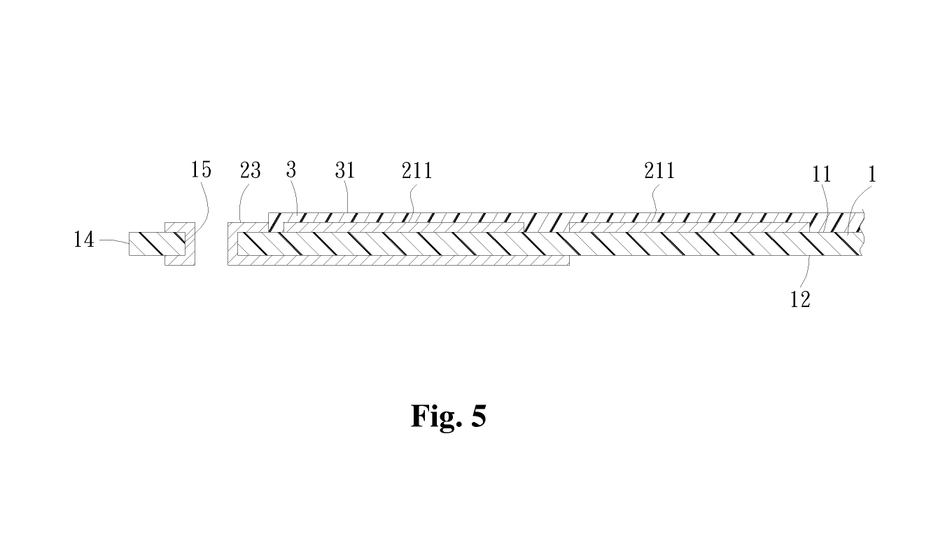

With reference to FIGS. 1, 4 and 5, in step 02, the insulating layer 3 is formed on the first surface 11 of the substrate 1. The insulating layer 3 covers the tracing units 21 and makes the first connecting traces 22 and the second connecting traces 23 partially exposed from the first surface 11 of the substrate 1. As shown in FIG. 5, the insulating layer 3 further comprises an outer surface 31 that is formed far away from the substrate 1.

With reference to FIGS. 1, 6 and 7, in step 03, the multiple connecting hole units 32 are formed on the insulating layer 3, are spaced at intervals along the first direction, and are overlapped with the corresponding tracing unit 21. Each connecting hole unit 32 communicates with the corresponding tracing unit 21, and are expansively duplicated along the second direction that comprises a pair of connecting holes 321. The two connecting holes 321 are corresponded respectively to two opposite end of the corresponding striped traces 211 of the tracing units 21.

With reference to FIGS. 1, 8 and 9, in step 04, the electrode layer 4 is printed on the outer surface 31 of the insulating layer 3. The electrode layer 4 comprises multiple first electrode rows 41 and multiple electrode units 42. The first electrode rows 41 are spaced at intervals along the second direction, and each first electrode row 41 comprises multiple first electrodes 411 and multiple first traces 412. The first electrodes 411 are spaced in intervals along the first direction, and mostly are shaped in a diamond-shape, except the first electrode 411 that closest to the first edge 13 is in a triangular shape. The first traces 412 are spaced at intervals along the first direction and each first trace 412 is electrically connected between the two adjacent first electrodes 411. The electrode units 42 are spaced at intervals along the second direction and each electrode unit 42 comprises multiple second electrodes 421 spaced at intervals along the second direction. Each second electrode 421 is electrically connected to the tracing unit 21 through the corresponding connecting hole unit 32, and mostly are shaped in a diamond-shape, except the second electrode 421 that closest to the second edge 14 is in a triangular shape.

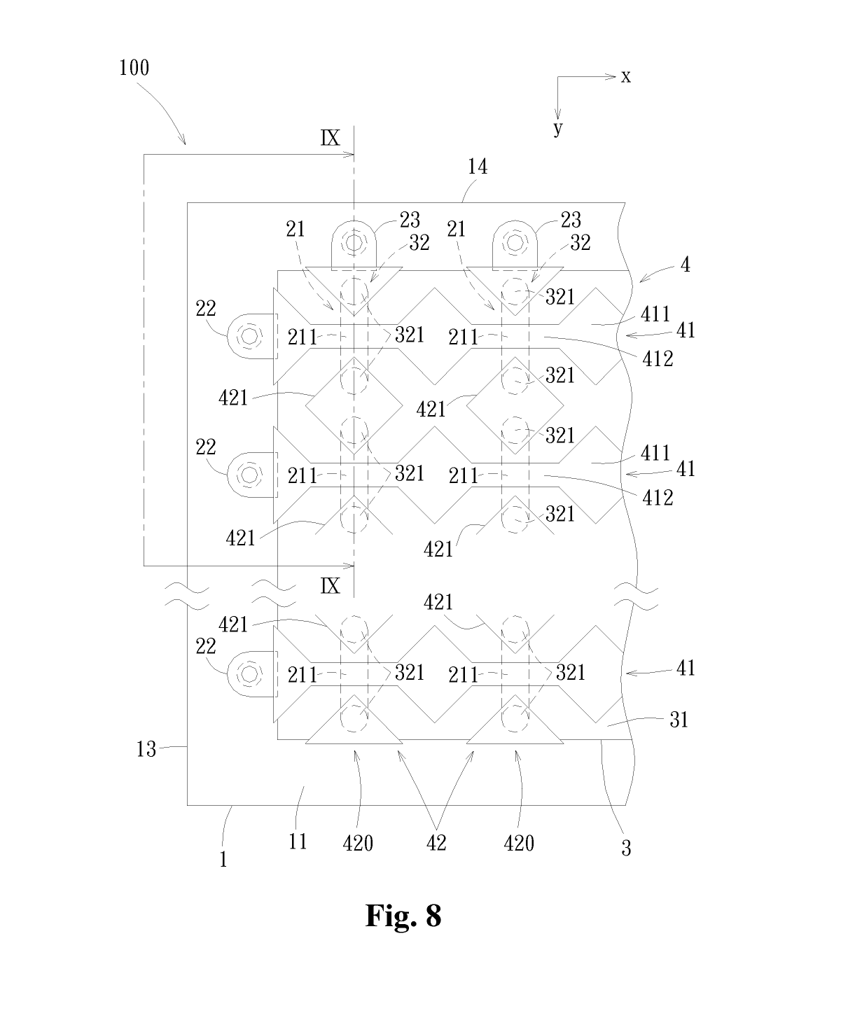

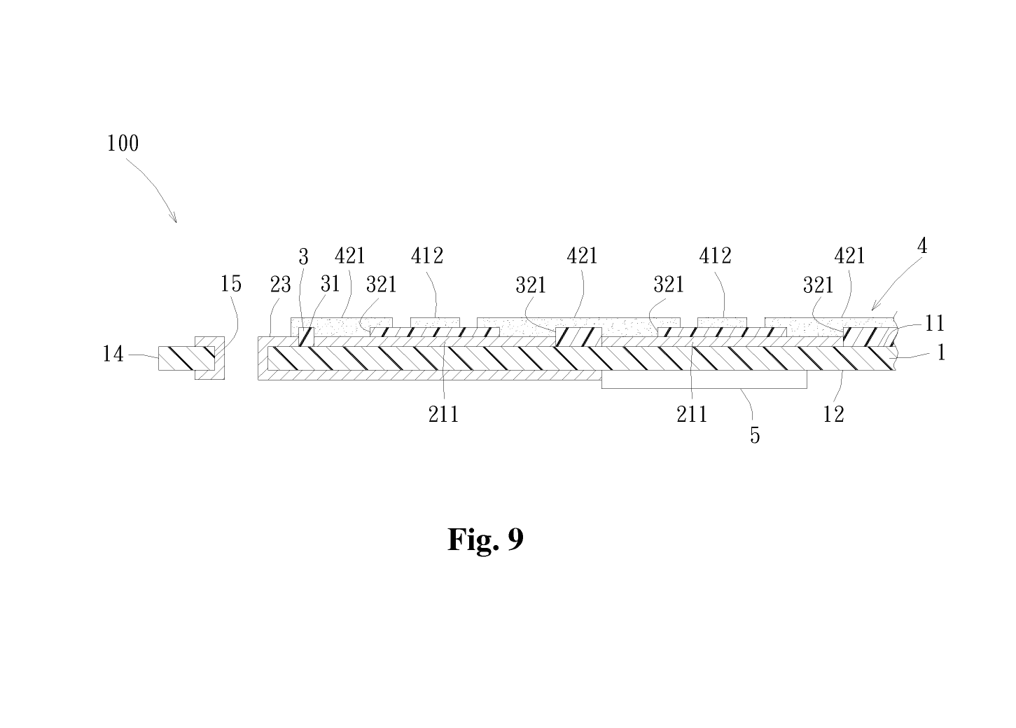

As shown in FIGS. 8 and 9, each second electrode 421 is overlapped with the two corresponding connecting holes 321 of the connecting hole unit 32. The connecting holes 321 communicate with the striped traces 211 of the tracing unit 21 respectively, which allow the striped traces 211 of the tracing unit 21 penetrates the corresponding connecting holes 321 to the two adjacent second electrodes 421 of the electrode unit 42. Accordingly, the second electrodes 421 are electrically coupled to form multiple second electrode rows 420 along the second direction.

The first electrode rows 41 are interlaced with the second electrode rows 420, the first electrode rows 41 are electrically connected to the first connecting traces 22, and the second electrode rows 420 are electrically connected to the second connecting trace 23. In this manner, signals of the first and second electrode rows 41, 420 are able to transmit to the second surface 12 of the substrate 1 through the first connecting traces 22 and the second connecting traces 23.

In one embodiment, the electrode layer 4 may be made from materials of a conductive ink The conductive ink can be, not limit to, selected from a group consisting of a silver ink, an aluminum ink, a silver-aluminum ink and a carbon ink.

Since the first electrodes 411 of the first electrode rows 41 and the second electrodes 421 of the first electrode rows 42 are formed substantially at same layer of a capacitive touch panel 100, it reduces the complexity of electrode alignments for positioning process during the manufacture. The overlapped of the first electrode 411 and the second electrode 421 can be avoided whereby printing the electrodes synchronized on the outer surface 31 of the insulating layer 3. Therefore, the accuracy of the touching detection is remained.

The capacitive touch panel 100, in step S05, further comprises the processing unit 5 mounted on the second surface 12 of the substrate 1. The processing unit 5 is electrically connected to the first electrode rows 41 and the second electrode rows 420, which receives signals from the first electrode rows 41 and the second electrode rows 420, and determines a position indicated the touch of the capacitive touch panel 100 based on the received signals.

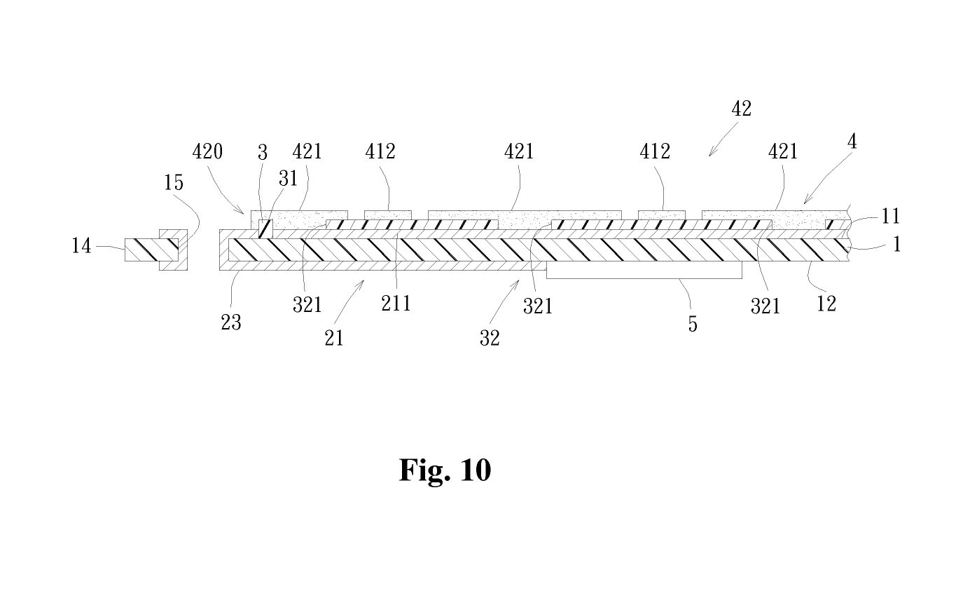

With reference to FIG. 10, illustrates another embodiment of the capacitive touch panel. In this embodiment, the tracing units 21 and the connecting hole units 32 have different structures from above mentioned embodiments. As shown in FIG. 10, the striped trace 211 of each tracing units 21 extended along the second direction, and is overlapped with two spaced second electrodes 421 of the second electrode unit 42.

Each connecting hole 321 of the connecting hole unit 32 is corresponded to the second electrodes 421 of the electrode unit 42, which allows the striped traces 211 electrically connecting to the second electrodes 421 of the electrode unit 42 through the connecting hole unit 32. In other words, each second electrode 421 is overlapped with one of the connecting holes 321 of the connecting hole unit 32, and thus the second electrode row 420 is formed whereby electrically coupling the second electrodes 421 of the electrode 42 to the corresponding connecting hole units 32 and the striped traces 211.

It is noted that the first electrode rows 41 and the second electrode rows 420 are aligned along the first direction and the second direction respectively, as previous mentioned and illustrated, the first and the second directions are perpendicular to each other, and thus the first electrode rows 41 are perpendicular to the second electrode rows 420. However, the angle of the first direction and the second direction may be an obtuse angle or an acute angle, so as to make the angle between the first electrode rows 41 and the second electrode rows 420 may be smaller or greater than 90 degree. Accordingly, the first electrode rows 41 may not always perpendicular to the second electrode rows 420.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A capacitive touch panel comprising:
a substrate having a first surface and a second surface;
multiple tracing units being spaced at intervals on the first surface of the substrate along a first direction, and each tracing unit duplicating along a second direction;
an insulating layer formed on the first surface of the substrate covering the tracing units, and comprising multiple connecting hole units penetrated to the corresponding tracing unit; and
an electrode layer being printed on an outer surface of the insulating layer, and comprising
multiple first electrode rows being spaced at intervals along the second direction, and duplicating along the first direction; and
multiple electrode units being spaced at intervals along the first direction, and duplicating along the second direction that comprise multiple electrodes spaced at intervals along the second direction, wherein the electrodes of the electrode units are electrically connected to the tracing units through the corresponding connecting hole units that forms multiple second electrode rows along the second direction.

2. The capacitive touch panel as claimed in claim 1, wherein the tracing unit is made from a metal.

3. The capacitive touch panel as claimed in claim 2, wherein the tracing unit is made of copper.

4. The capacitive touch panel as claimed in claim 2, wherein the electrode layer is made from a conductive ink.

5. The capacitive touch panel as claimed in claim 4, wherein the electrode layer is made from materials selected from a group consisting of a silver ink, an aluminum ink, a silver-aluminum ink and a carbon ink.

6. The capacitive touch panel as claimed in claim 4, wherein
the each tracing unit comprises multiple striped traces spaced at intervals along the second direction; and
the each connecting hole unit comprises multiple connecting holes along the second direction, and the every two connecting holes are corresponded respectively to two opposite end of the corresponding striped traces of the tracing units, wherein the striped traces of the tracing units are electrically connected to the two adjacent electrodes of the electrode units through the corresponding connecting holes.

7. The capacitive touch panel as claimed in claim 4, wherein
each tracing unit comprises a striped trace extended along the second direction; and
each connecting hole unit comprises multiple connecting holes corresponded to the electrodes of the corresponding second electrode unit, wherein the striped trace is electrically connected to the electrodes of the corresponding electrode unit through the corresponding connecting holes.

8. The capacitive touch panel as claimed in claim 4, further comprising:
a processing unit being mounted on the second surface of the substrate, and being connected electrically to the first electrode rows and the second electrode rows, which receives the signals from the first electrode rows and the second electrode rows.

9. The capacitive touch panel as claimed in claim 8, wherein the electrode is shaped in a diamond-shape or a triangular shape.

10. The capacitive touch panel as claimed in claim 9, wherein the first direction is perpendicular to the second direction.

11. A method for manufacturing a capacitive touch panel, comprising:
forming multiple tracing units spaced at intervals along a first direction on a first surface of the substrate, wherein each tracing unit is extended along a second direction that intersects the first direction;
forming an insulating layer covered on the tracing units on the first surface of the substrate;
forming multiple connecting hole units on the insulating layer, wherein the connecting hole units penetrate to the corresponding tracing units; and
printing an electrode layer on a outer surface of the insulating layer that is away from the substrate, wherein the electrode layer comprises multiple first electrode rows and multiple electrode units, the first electrode rows are spaced at intervals along the second direction, and duplicating along the first direction, and the electrode units are spaced at intervals along the first direction, and duplicating along the second direction that comprises multiple electrodes spaced at intervals along the second direction, wherein the electrodes of the electrode units are electrically connected to the tracing units through the corresponding connecting holes that forms multiple second electrode rows along the second direction.

12. The method as claimed in claim 11, wherein the tracing unit is made from a metal.

13. The method as claimed in claim 12, wherein the tracing unit is made of copper.

14. The method as claimed in claim 12, wherein the electrode layer is made from a conductive ink.

15. The method as claimed in claim 14, wherein the electrode layer is made from materials selected from a group consisting of a silver ink, an aluminum ink, a silver-aluminum ink and a carbon ink

16. The method as claimed in claim 14, wherein the each tracing unit comprises multiple striped traces spaced at intervals along the second direction; and
the each connecting hole unit comprises multiple connecting holes along the second direction, and the every two connecting holes are corresponded respectively to two opposite end of the corresponding striped traces of the tracing units, wherein the striped traces of the tracing units are electrically connected to the two adjacent electrodes of the electrode units through the corresponding connecting holes.

17. The method as claimed in claim 14, wherein each tracing unit comprises a striped trace extended along the second direction; and
each connecting hole unit comprises multiple connecting holes corresponded to the electrodes of the corresponding second electrode unit, wherein the striped trace is electrically connected to the electrodes of the corresponding electrode unit through the corresponding connecting holes.

18. The method as claimed in claim 14, further comprising:
mounting a processing unit on the second surface of the substrate electrically connected to the first electrode rows and the second electrode rows, which receives the signals from the first electrode rows and the second electrode rows.

19. The method as claimed in claim 18, wherein the electrode is shaped in a diamond-shape or a triangular shape.

20. The method as claimed in claim 19, wherein the first direction is perpendicular to the second direction.
